(19) United States
(12) Patent Application Publication
(10) Pub. No.: US 2008/0021696 A1
(43) Pub. Date: Jan. 24, 2008

(54) System and method of providing a fast path link for an identified set of data

(75) Inventors: Jay D. Bartelt, Wheeling, IL (US); Jonathan E. Gabriel, Round Lake Beach, IL (US)

Correspondence Address: FRANCIS C. KOWALIK;WALGREEN CO. LAW DEPARTMENT, 104 WILMOT ROAD, M.S. #1425, DEERFIELD, IL, 60015, US

(73) Assignee: WALGREEN CO., Deerfield, IL (US)

(21) Appl. No.: 11/489,382

(22) Filed: Jul. 19, 2006

(51) Int. Cl. G06F 9/455

(52) U.S. Cl. 703/27

(57) ABSTRACT

The claimed method and system collects an alert link for display at a client device. The alert link may be associated with a trigger placed on a parameter associated with a legacy application. The alert link may be used to retrieve security and configuration data for the associated legacy application to dynamically activate an interface to the legacy application and configure the legacy application to a target state that enables a user to easily retrieve necessary data.

### FIELD OF THE INVENTION

The present invention generally relates to a process for managing user access to legacy applications and/or legacy application data.

### BACKGROUND

Existing legacy application providers, such as midrange applications running on IBM AS/400s, may provide an emulator for execution on a modern personal computer (PC). While these emulators may be able to provide users access to the legacy application from a PC, the user interface for these emulators remains similar to their terminal screen counterpart, including all the navigation difficulties and other drawbacks associated with terminal screen access. In other words, emulators may only enable the same type of user access to legacy applications as previous terminal devices, without any improvement in the way in which application data is accessed. These emulators may provide a series of menu screens that are difficult to navigate and make it time consuming for a user to retrieve data. Moreover, a particular user may be required to access several legacy applications to retrieve necessary information, thereby adding to the complexity a user may face in performing tasks.

In an example situation, a user may need to resolve a dispute with an existing customer which requires accessing customer payment information and product shipping details. If the accounting system providing information on payments is different from the system for inventory and shipping, then two different emulators may need to be used to navigate a legacy system and retrieve the necessary information. Thus, in order for the user to retrieve the information necessary to make a decision and interact with the customer, the user may need to activate and separately navigate two legacy applications via two different emulators. Because a typical day may involve many of these information searches per user, user performance could be greatly improved by streamlining access to legacy applications and/or legacy application data.

Moreover, because there may be more than one legacy system, as discussed, monitoring these systems for critical conditions may be hampered by complexity in interfacing with the system. In some situations, where the timing of results is critical, (e.g., dispute resolution, shipping, inventory stocking, etc.) failure to monitor certain conditions may greatly impact operations.

### SUMMARY OF THE INVENTION

The claimed method and system enables alerts to be set up across legacy applications and to aggregate and display those alerts to a user using alert links. Further, the claimed method and system allows a user to select the alert links which will activate an emulator corresponding to the legacy application managing the data associated with the alert and bring the emulator to a state or condition in which the user may act upon the alert. For example, if the alert is related to an inventory program that is managed by an AS/400 application, the claimed method and system may provide an alert link for display to a user, and, upon selecting the alert link, the claimed method and system may activate an emulator and execute a set of menu selections (or alternatively, provide the application with other configuration data to place the application in a particular state) before returning control to the user. This preconfigured state may be an actual inventory screen on the emulator which provides the user the necessary data to resolve the alert. Alternatively, the link may take the user to an input screen in which the user simply needs to enter or update information required to resolve the alert.

### BRIEF DESCRIPTION OF THE DRAWINGS

FIG. 1-3 illustrates a block diagram of a computing system that may operate in accordance with the claims;

FIG. 4 illustrates an embodiment of the alert generation process;

FIG. 5 illustrates an embodiment of the contents of an alert in the form of an XML file;

FIG. 6 illustrates an embodiment of a user work flow process;

FIG. 7 illustrates an example of an alert display at a client browser;

FIG. 8 illustrates an embodiment of the alert link generation process;

FIG. 9 illustrates an AS/400 emulator activation screen;

FIG. 10 illustrates a series of AS/400 emulator menu selections;

FIG. 11 illustrates a target AS/400 emulator screen for claim review;

FIG. 12 illustrates a security process that may be implemented in one embodiment;

FIG. 13 illustrates an alert activation process incorporating a security check; and

FIG. 14 illustrates that the client applet may be an ActiveX control.

### DETAILED DESCRIPTION

Although the following text sets forth a detailed description of numerous different embodiments, it should be understood that the legal scope of the invention is defined by the words-of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

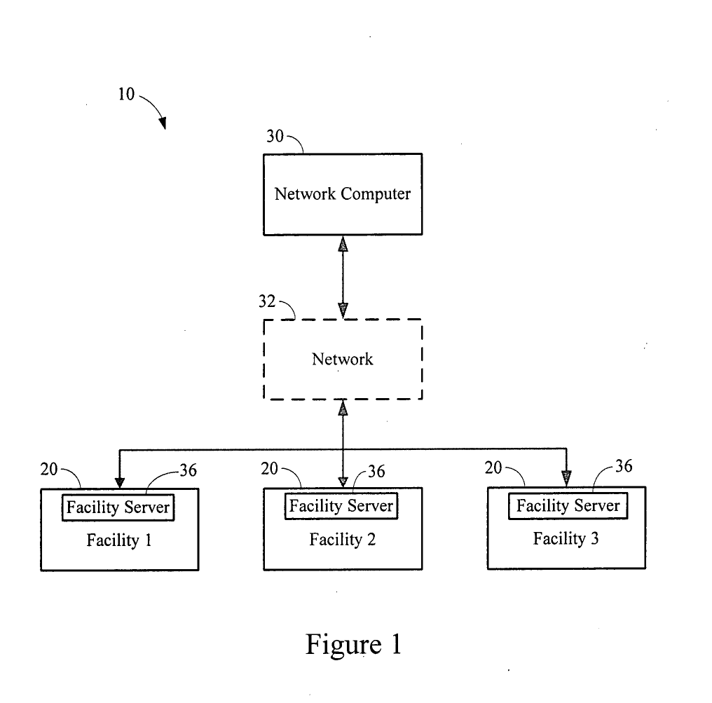

FIG. 1 illustrates an embodiment of a data network 10 including a first group of pharmacies 20 operatively coupled to a network computer 30 via a network 32. The plurality of pharmacies 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download pharmacy data. For example, the network computer 30 may periodically receive data from each of the pharmacies 20 indicative of information pertaining to a prescription order, billing information, employee data, etc. The pharmacies 20 may include one or more facility servers 36 that may be utilized to store information for a plurality of customers/employees/accounts/etc. associated with each facility.

Although the data network 10 is shown to include one network computer 30 and three pharmacies 20, it should be understood that different numbers of computers and pharmacies may be utilized. For example, the network 32 may include a plurality of network computers 30 and dozens of pharmacies 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating pharmacy data.

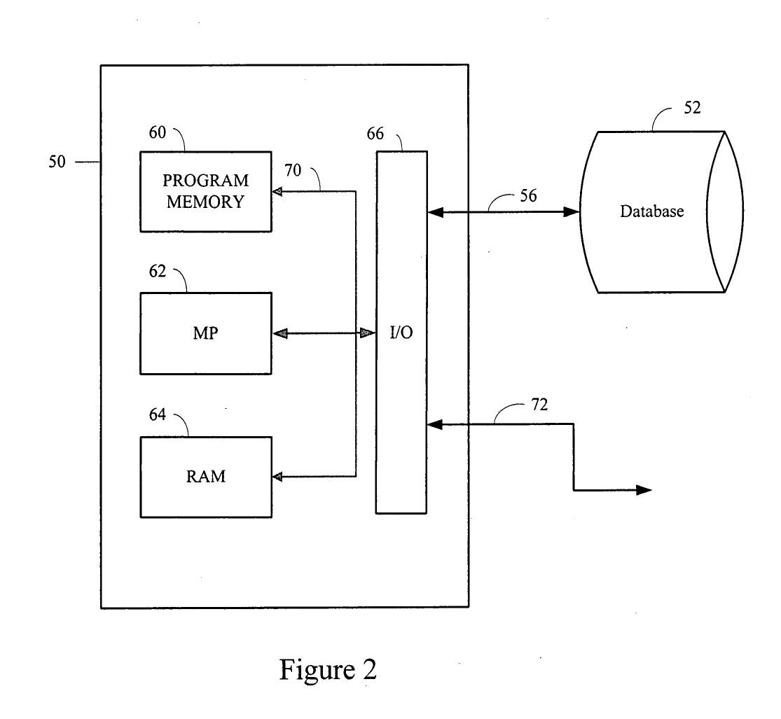

FIG. 2 is a schematic diagram of one possible embodiment of the network computer 30 shown in FIG. 1. The network computer 30 may have a controller 50 that is operatively connected to a database 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (1/0) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the 1/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

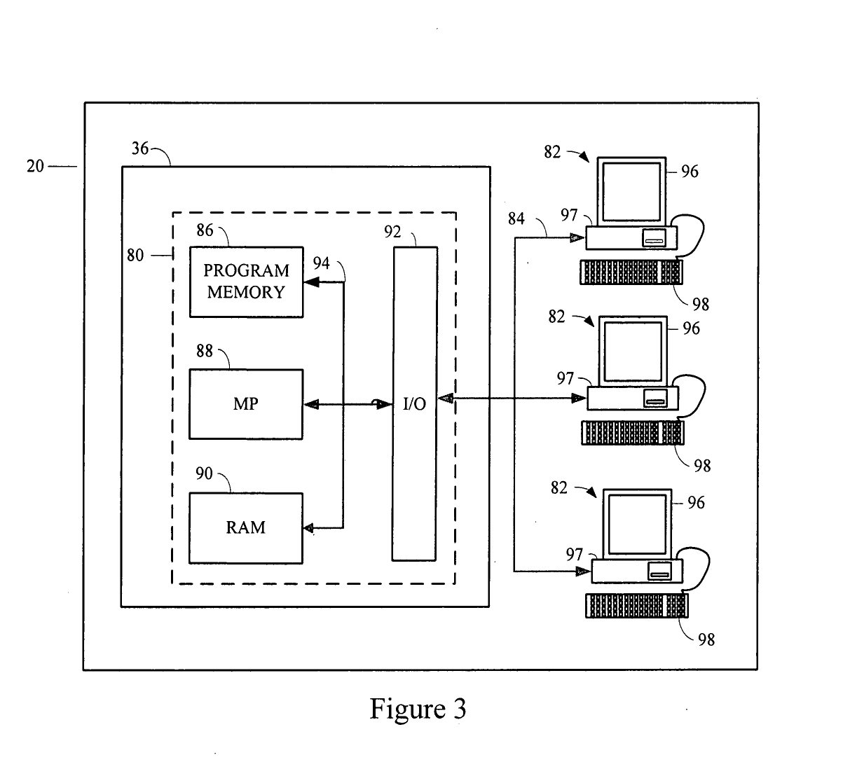

FIG. 3 is a schematic diagram of one possible embodiment of several components located in one or more of the pharmacies 20 from FIG. 1. Although the following description addresses the design of the pharmacies 20, it should be understood that the design of one or more of the pharmacies 20 may be different than the design of other pharmacies 20. Also, each pharmacy 20 may have various different structures and methods of operation. It should also be understood that the embodiment shown in FIG. 3 illustrates some of the components and data connections present in a pharmacy, however it does not illustrate all of the data connections present in a typical pharmacy. For exemplary purposes, one design of a pharmacy is described below, but it should be understood that numerous other designs may be utilized.

The pharmacies 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a scanner, printer, mouse, touch screen, track pad, track ball, isopoint, voice recognition system, etc. Each client device terminal 82 may be signed onto and occupied by a pharmacy employee to assist them in performing their duties. Pharmacy employees may sign onto a client device terminal 82 using any generically available technique, such as entering a user name and password. If a pharmacy employee is required to sign onto a client device terminal 82, this information may be passed via the link 84 to the facility server 36, so that the controller 80 will be able to identify which pharmacy employees are signed onto the system and which client device terminals 82 the employees are signed onto. This may be useful in monitoring the pharmacy employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

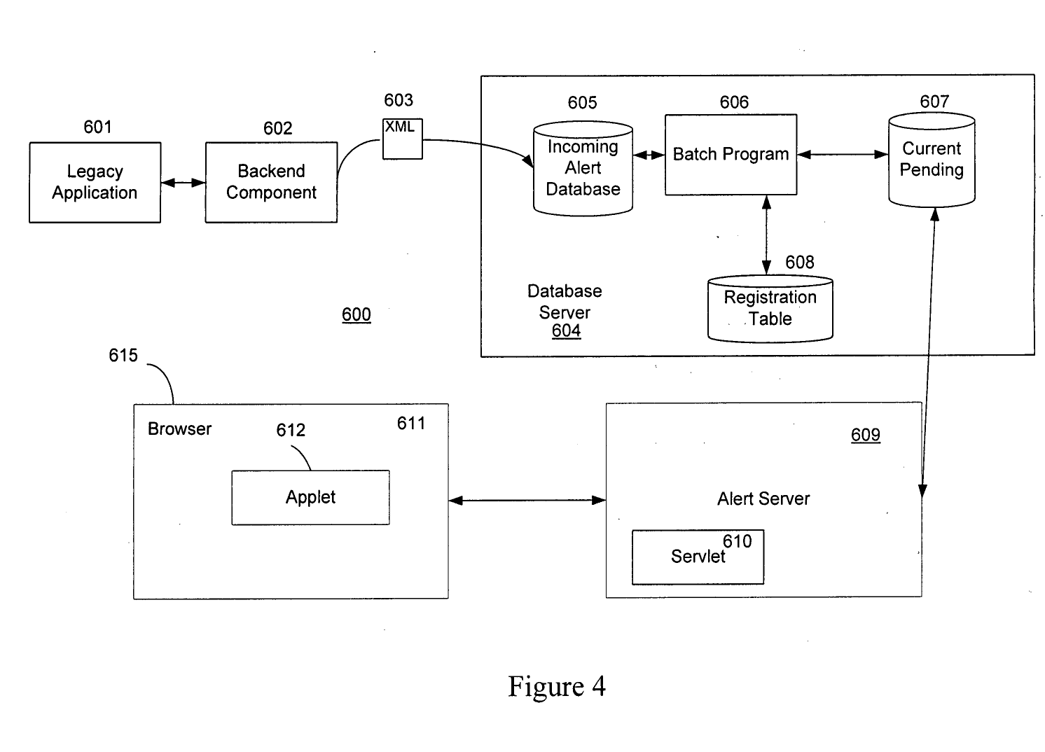

FIG. 4 illustrates an embodiment of an alert generation system 600. The alert generation system 600 may include several legacy applications 601 and enterprise applications. In one embodiment, a backend component or application 602 may be created and run on a first server (not illustrated). The backend component may monitor certain parameters of a legacy application 601 by defining a trigger for a legacy application parameter. For example, a trigger may be placed on a product inventory level parameter, such that when the parameter value falls below a certain threshold, which may indicate a fall in inventory level beyond a designated value, the backend application 602 may generate an alert corresponding to the trigger. The alert may be in the form of an XML file 603 or other file format, which provides basic alert parameters. This alert file 603 may be sent to a central location, such as an incoming alert folder, directory, or database 605 for processing. In one embodiment, the file 603 may be loaded to a second server, such as a dedicated database server 604, via file transfer protocol (FTP) or other communication methods. It should be noted that the first server running the backend component may be a server running the legacy application.

Alternatively, an alert may be manually created by a user and a corresponding XML file 603 generated and sent to the database server 604. Manual alert creation may be needed when an alert is based on a condition external to the software applications for a business. For example, an inventory recall message may be sent to an individual of a company, such as a manager, independent of any software application that may require action by a certain employee. The manager may manually create an alert and send it to the alert database server 604. A batch program 606 may work on the received alert files 603 (e.g., XML files), once received in the incoming alert folder, directory, or database 605. The batch program 606 may parse through the XML files 603 to separate the alert parameters and load those parameters into a pending alert table 607. Each alert 603 may also have an alert identifier that may be used to associate the generated alert with further alert information. In one embodiment, an alert registration index, table or database 608 may be created in the database server 604 or another server communicatively coupled to the batch program 606. The batch program 606 may then retrieve further alert information from the registration table 608 based on an alert identifier of a particular alert. In one embodiment, the batch program may query all necessary alert information and populate a record entry in the alert table 607 at one time. The retrieved information may be further recorded in the pending alert table 607 or may be linked to the record of the alert and stored in a separate table, database, or other storage device. The alert table 607 may represent a listing of all pending alerts with links to alert information from the registration database 608.

The alert generation system 600 may further include a routing component such as a servlet 610 that routes a particular alert based on the values of certain parameters of the alert. The routing component may be a separate component running on a third server, such as an alert server (see below) or routing may be performed by another batch program on database server 604 (not shown). For example, the alert may have a role parameter associated with the alert. In one embodiment, the roles may be assigned as part of the information stored in the alert registration table 608 and retrieved by the batch program 606 during the parsing process described above. In this manner, routing may be predefined via a single registration process, where the routing component acts to route an alert based on the role. It should be noted, that the monitoring component of the backend component, the alert data collection of the database server and the alert transmission and or routing of the alert server may be performed by a single server or more than three servers. The embodiments described herein are merely exemplary of a topological layout.

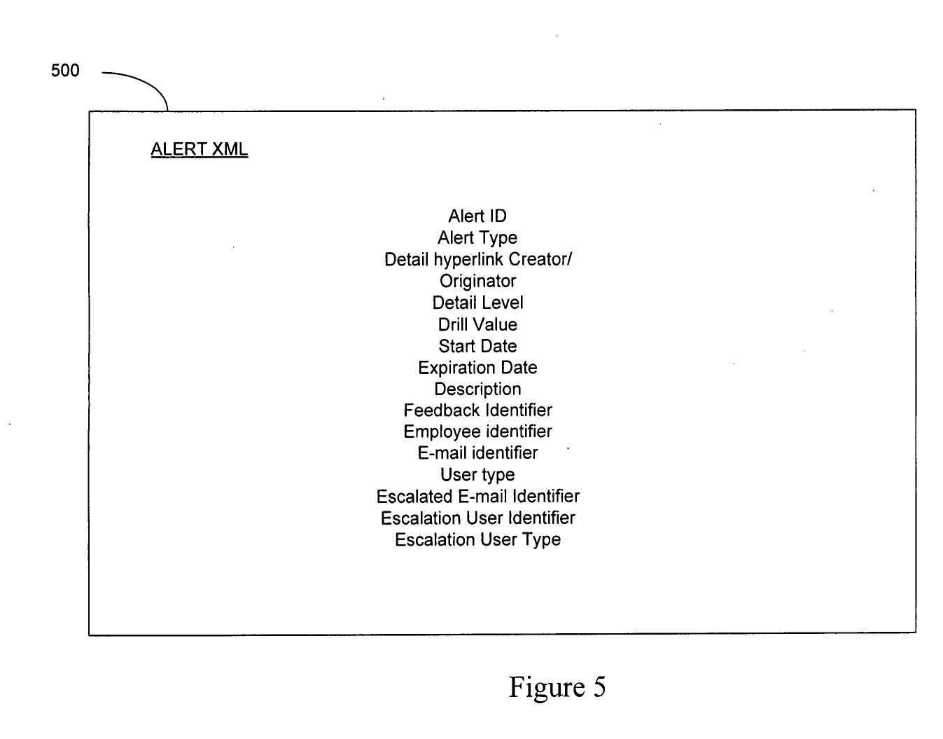

FIG. 5 illustrates an embodiment of the contents of an alert in the form of an XML file 500. As illustrated, an alert may include an alert identifier, alert type, detail hyperlink, creator/originator, detail level, drill value, start date, expiration date, description, feedback identifier, employee identifier, e-mail identifier, user type, escalated e-mail identifier, escalation user identifier, escalation user type, and other parameter values.

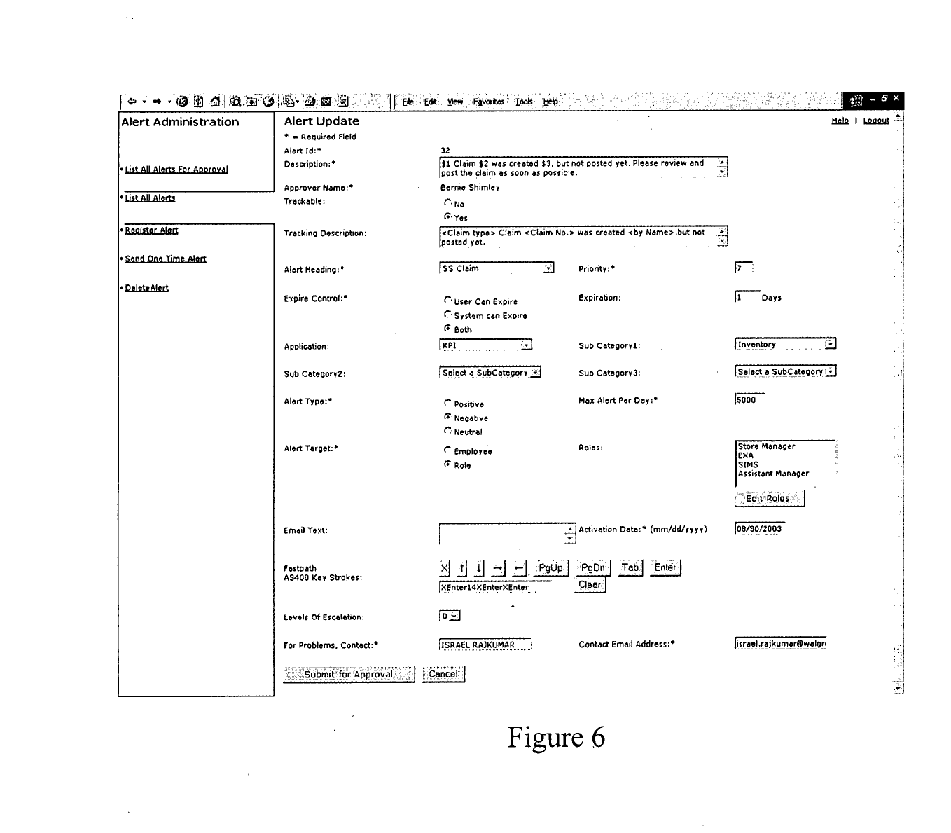

FIG. 6 illustrates an embodiment of a registration table entry screen. The screen may be presented to a user when establishing or creating a new alert registration; or editing or modifying an existing entry.

Referring again to FIG. 4, the routing component 610 may be a server-side application for dynamically-generating web pages, such as a servlet 610, and providing those web pages to a client browser 615. In one embodiment, the servlet 610 may be hosted on an alert server 609 that may be responsible for querying the pending alerts database 607 and generating a webpage including a listing of the alerts. Server-side technologies for dynamically-generated web pages may include JAVA Servlet and Active Server Pages (ASP). In another embodiment, a server and client application program may be used instead of a servlet and browser configuration.

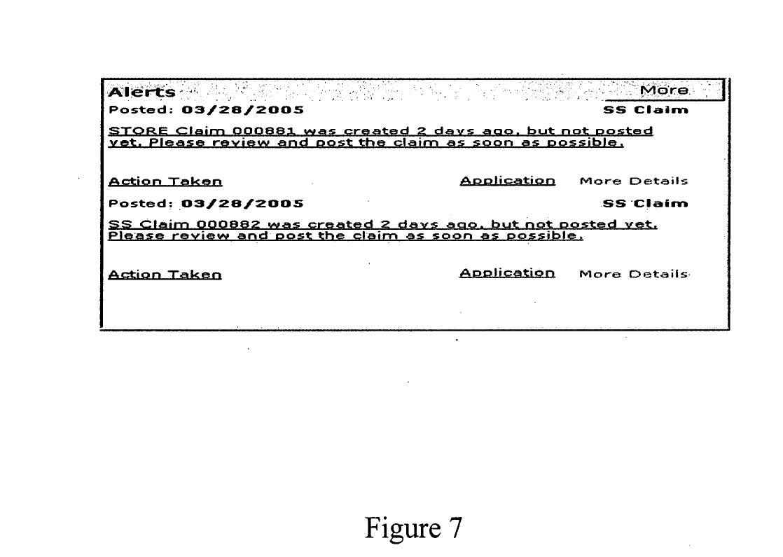

An example of an alert display at a client browser is illustrated in FIG. 7. In addition to the basic functionality of generating web pages for outputting a display of the alerts to a browser, the servlet 610 may also serve to prioritize the alerts, escalate the alerts, reassign alerts, update an expiration for an alert, and move, copy, or reroute alerts. Some of the modifications to an alert may be performed by using a screen similar to that illustrated in FIG. 6 and displayed by the servlet 610.

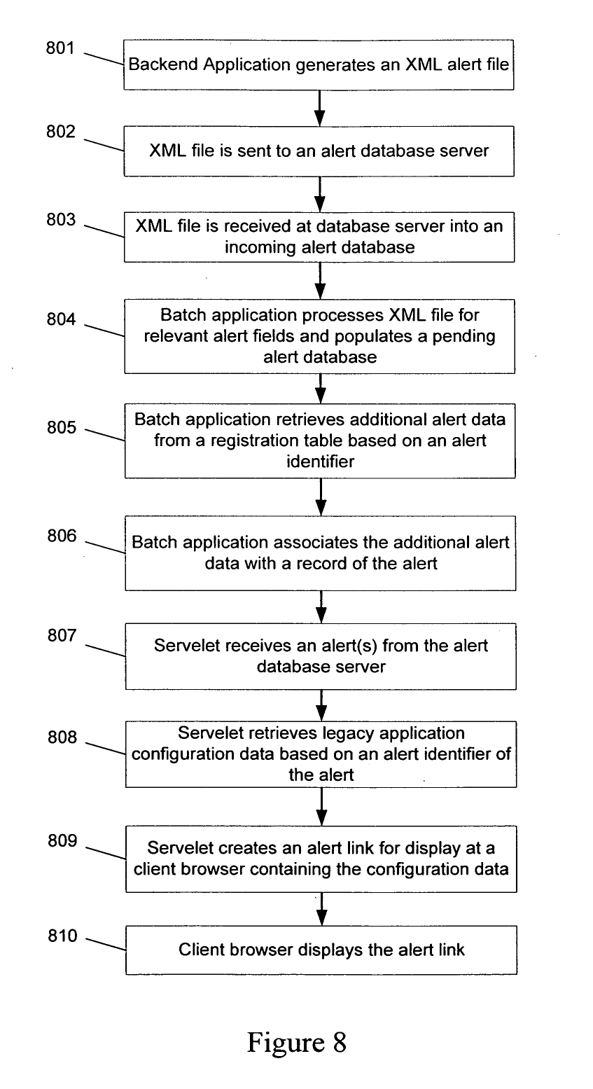

FIG. 8 illustrates an embodiment of the alert link generation process. After an alert is generated by a backend application 801, an XML representing the alert may be sent to an alert database server 802 and received into an incoming alert folder, directory, or database 803. A batch application running on the database server may then parse through and reformat the contents of the XML file for entry into a record of a pending alerts database 804. Additionally, the batch application may retrieve additional alert information from a registration database and associate the additional information with the record in the pending alerts database 805, 806. A servlet, which may be running on an application server, may receive the alert from the alert database server (for example, via a query of the alert database by the servlet) 807 and retrieve configuration data for a legacy application that is related to the alert 808. The servlet may retrieve legacy application configuration data based on the alert identifier associated with the alert. This configuration data may be stored in an index, such as the alert registration database, and referenced by an alert identifier. In an embodiment discussed above, the additional information may be linked to the alert record by a batch process. Alternatively, the servlet may pull information directly from the alert registration database when invoked. Once the configuration data is retrieved, an alert link may be generated for display at a client browser 809, 810. An example of a possible path link that is shown as an alert in a browser may be:

http://snetapplocal.company.com/FastpathWeb/servlet/company.snet.-
fastpath.proxy.FastpathServletProxy/FastpathRequestHandler&ActionId=
OPEN_WRAPPER_WINDOW?KyStrks=0d,58,0d,
14,14,14,14,14,14,14,14,58,0d,58,0d

The configuration data may be used to initialize a legacy application or third party application to a state based on the alert. For example, the displayed alert may indicate that there is a discrepancy in a customer account relating to a payment received. Typically, as discussed above, a user may have to determine which legacy application stores the related payment data, start an emulator for the legacy application, and then enter certain parameters to bring the user to an application state that is helpful in providing the data. In the claimed method and system, upon selecting the alert link, a legacy application may be activated and configured to a state based on the configuration data, thereby placing the legacy application in a state to more immediately assist the user based on the alert. It should be noted that in an alternative embodiment, instead of the link containing the application configuration data, the link may contain a reference to the configuration data that may be easily accessed upon activating the link.

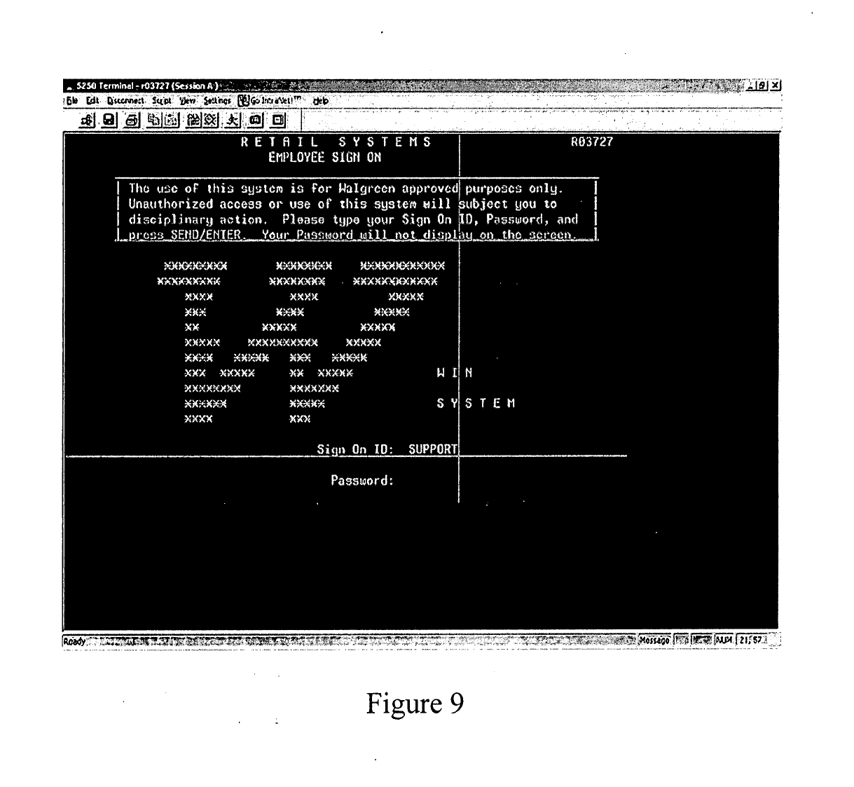

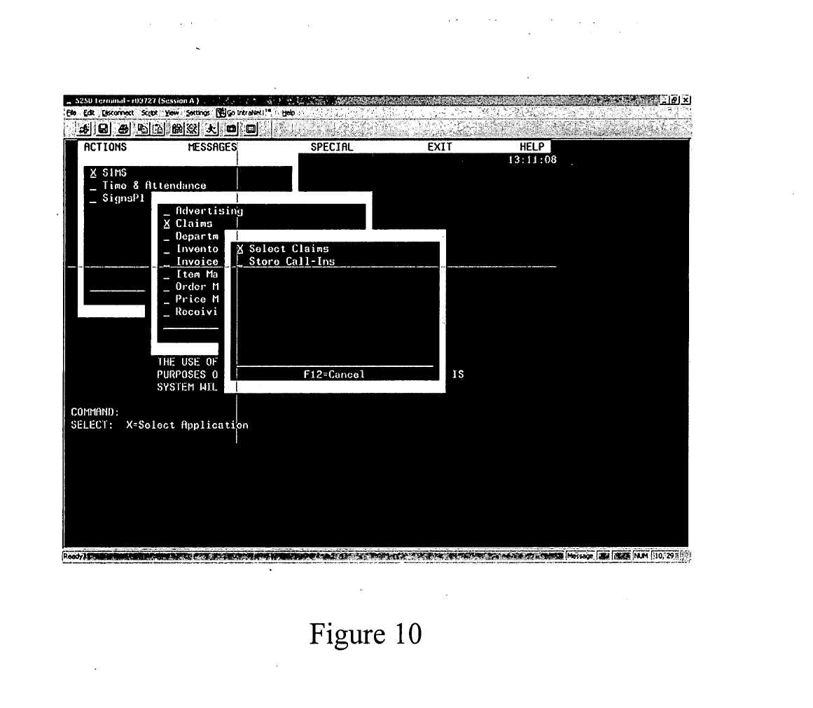

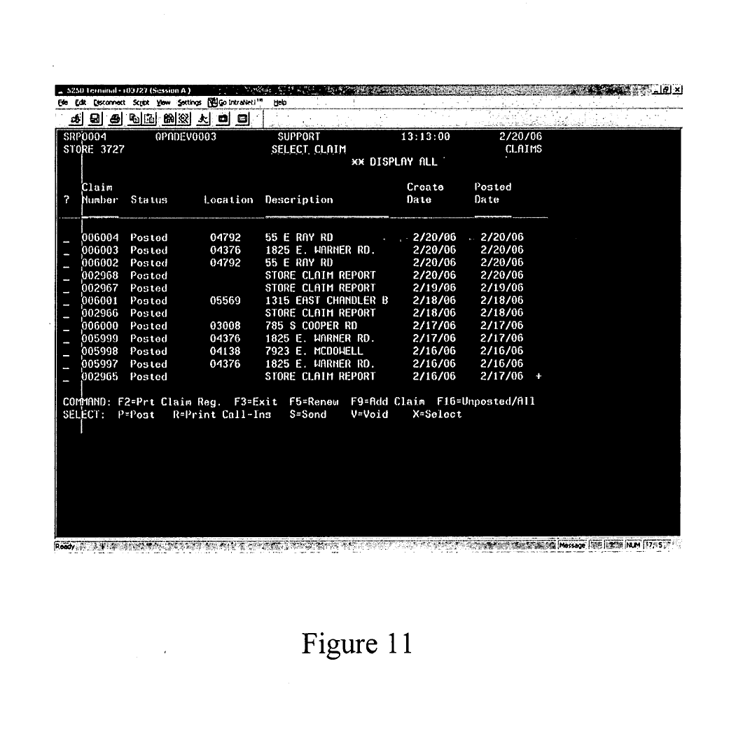

In one embodiment, the configuration data may be a menu sequence for an emulator. Because an emulator may only be able to take basic key stroke entries to navigate to a particular screen, the menu sequence may execute a sequence of menu selections to automatically navigate the emulator to a particular screen which may provide the user the necessary information or functionality. For example, in a situation in which an inventory alert is generated, selecting the alert link may activate an AS/400 emulator (See FIG. 9) and initiate entry of keystrokes into the emulator representing menu selections (See FIG. 10) to bring the AS/400 emulator to a target screen for claim review (See FIG. 11). The use of alert links to bring a third party application to a designated state based on the alert or alert type may greatly reduce user complexity and increase user performance.

In another embodiment, the configuration data may not be keystrokes but instead be configuration parameters that are passed into the legacy application to provide the necessary state in which the user may then operate. For example, the configuration data may be an initialization file, such as a text file, or any other type of file that is recognized by the legacy application for placing the legacy application in a particular state, according to the alert type. In embodiment, an alert type may be used to associate a plurality of alerts with the same configuration data or menu sequence.

In another embodiment, the configuration data may be search parameters used to initialize a search function in the legacy application which may provide search results relevant to a user alert.

In another embodiment, security functions may supplement the configuration data. For example, many legacy applications, such as terminal emulators, may require a logon process before access to any function menus are provided. Generally, this may also slow down a user in performing his or her assigned task because the user may be required to login to each legacy application used, each time the user accesses the application(s).

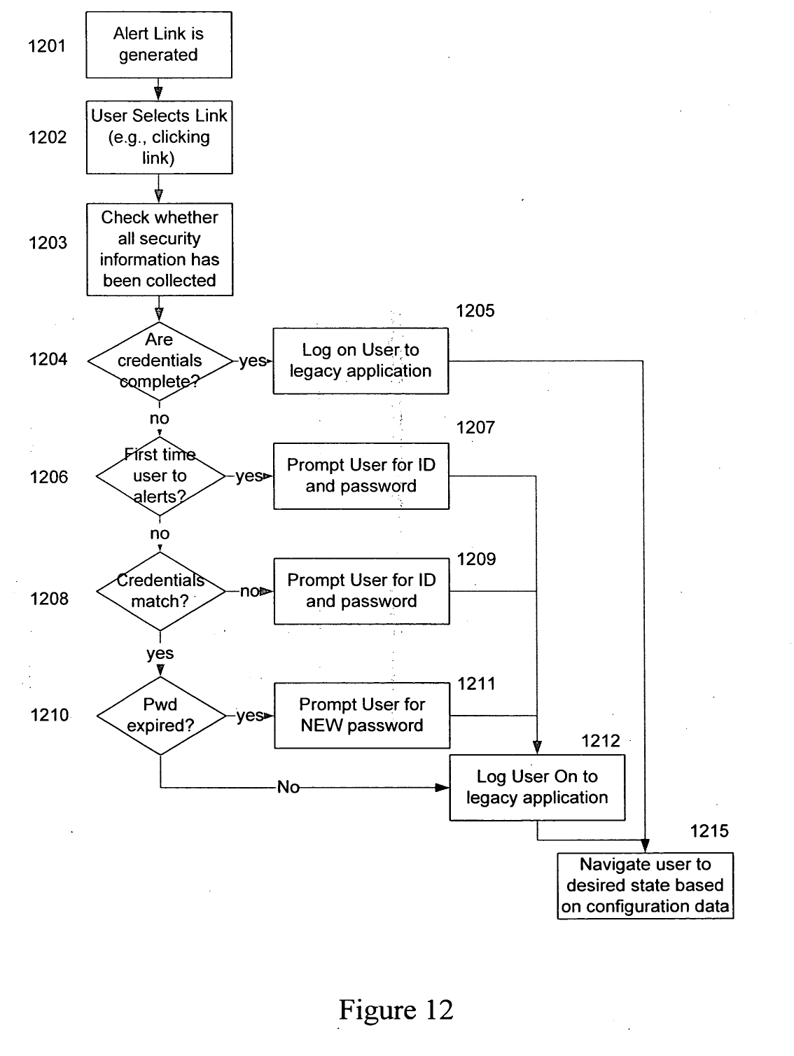

FIG. 12 illustrates a security process that may be implemented in one embodiment. An alert link may be generated for the user in an alert screen 1201 such as that illustrated in FIG. 7. When the user selects the link or clicks the link 1202, a check may be made to determine whether all required information for accessing a target legacy application (based on the alert link) has been collected 1203 (this collection may be at the client or server side, to be further explained below). If the user credentials are complete 1204, the user may be logged on to the application 1205 and the application may be configured to a corresponding state based on the configuration data 1215. If this is the first time the user is using the system or the user credentials are incomplete 1206, then the system may prompt the user for a user ID and password 1207. After successful logon of the user, the user may be logged on to the application 1212 and the application placed in the appropriate state 1215.

If the user password or identifier is otherwise invalid or does not match 1208, the system may prompt the user for a user ID and/or password 1209. After successful logon of the user, the user may be logged on to the application 1212 and the application placed in the appropriate state 1215. In one embodiment, passwords and/or accounts may have an expiration date. If the user account (e.g., based on user ID) or password is expired 1210, then the system may prompt user for a new password 1209 or ask for validating information to renew an account before logging the user on to the application 1212 and placing the application in the appropriate state 1215.

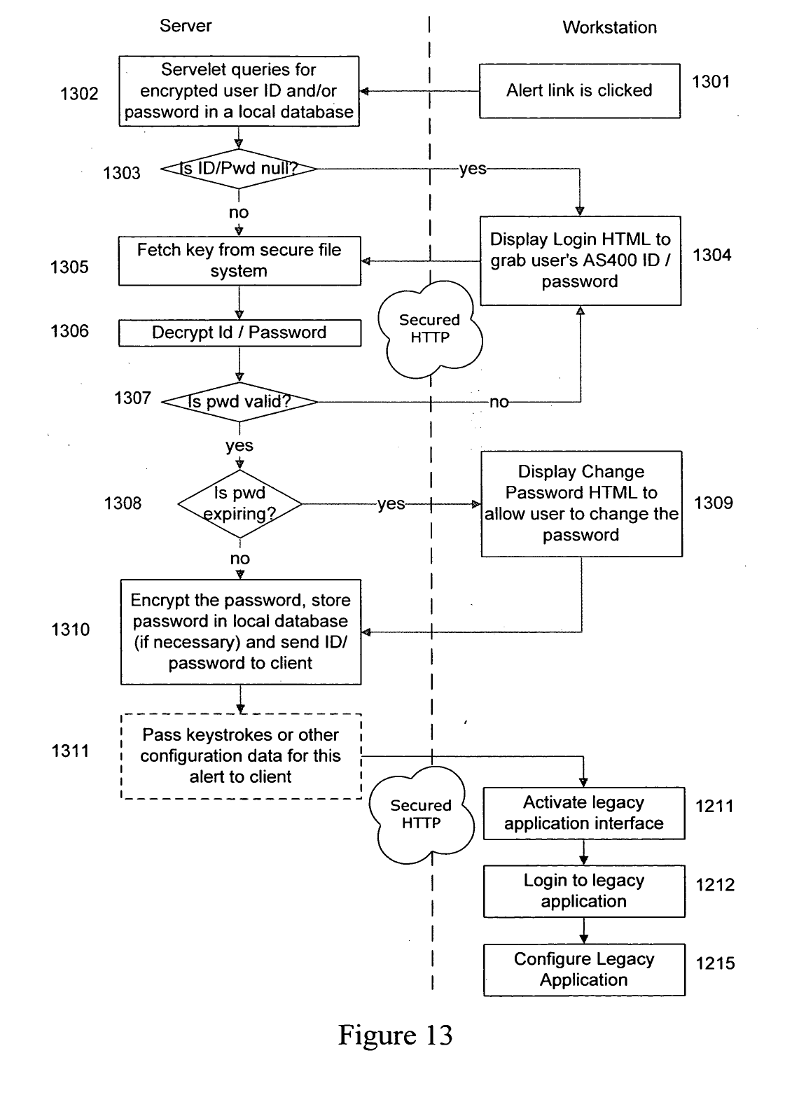

FIG. 13 illustrates an alert activation process incorporating a security check. An alert link may be clicked at a client browser 1301. This may activate a security function on the servlet 1302. For example, the servlet may look up a password for a legacy application based on a user identifier passed in to the server during an earlier login process for the servlet. This user identifier may be encrypted and the lookup may be based on the encrypted form of the user identifier. The password retrieved may also be in encrypted form. The password may be retrieved via a query to a legacy application database or a central security administration server. If the password is null 1303, for example, if the password is not available or does not exist for the user identifier passed in, then the servlet may provide a page for display at the client browser showing a login screen 1304 that prompts the user to enter a login identifier and password for the legacy application associated with the alert link (e.g., an AS/400 legacy application).

If the password is not null 1303, then a key may be used to decrypt the password and/or identifier and validate the password and/or identifier 1305. Validation may entail checking a format or syntax of the password or identifier. If the password is invalid 1307, then the servlet may cause a login screen at the client browser 1304 prompting the user for login information for a legacy application. If the password is valid 1307, then an additional check may be made to determine whether the password has expired 1308 or is about to expire. If the password is expired or is about to expire, then the servlet may push a screen that gives a user the option of changing the user password 1309. If the user does supply a new password, the password may be encrypted using a key and the legacy application may be updated to associate the new password to the user ID. In one embodiment, the updated password may be stored in a local database at the application server or alert server for future use 1310, for example, when the user needs to log back in to the legacy application for an additional query. If the password has no expiration problem, the servlet may encrypt the password (if not already encrypted) and pass login information to the client 1310.

In the embodiment described above, the configuration data for a legacy application associated with an alert may be retrieved with the record in the pending alert database or retrieved when the servlet creates a link for the alert. In yet another embodiment, the configuration data may be retrieved during the alert link activation process 1311 and passed to the client with the security information (e.g., ID and/or password). Once the security information and configuration data is passed back to the client, a client application, such as an client applet, may be used to activate a legacy application interface 1211, such as an emulator, that logs the user into the legacy application 1212 and configures the legacy application based on the configuration data 1215.

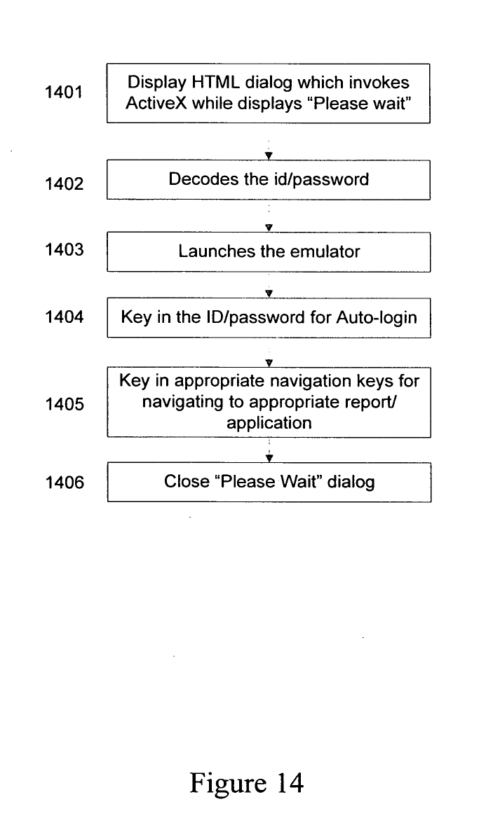

FIG. 14 illustrates that the client applet may be an ActiveX control. It should be noted, that other suitable applets may be used as well. The ActiveX control may display a “Please wait” 1401 or other message during the activation and configuration of the legacy application. The ActiveX control may be used to decode the user ID and/or password received from the server 1402, launch or activate a legacy application emulator 1403, key in the user ID and/or password 1404, and configure the emulator or legacy application to appropriate state 1405, thereafter closing any status window initially displayed 1406.

The claimed method and system of generating and collecting alert links across a plurality of legacy applications enables a user to more easily monitor priority tasks that the user must attend to. Moreover, the claimed method and system of retrieving and using configuration data to automatically configure a legacy application reduces the need for a user to remember or figure out exact menu sequence or other configuration information to access relevant data. The claimed configuration process also may save a user time from having to input configuration data each time the user needs to access a particular legacy application. The claimed method and system also reduces the complexity of legacy applications by automating the security process for a user.

What is claimed:

1. A method of initializing a legacy system from a web based application, the method comprising:
creating an alert having an associated alert identifier;
creating an index that associates an application menu sequence with the associated alert identifier;
retrieving the application menu sequence from the index based on the alert identifier;
creating a link in an application for the alert, wherein the link includes a message and the retrieved application menu sequence; and
upon selecting the link, initiating a legacy application emulator and placing the emulator in a state based on the retrieved application menu sequence.

2. The method of claim 1, further comprising:
retrieving a user identifier and a user password from a previous login attempt;
retrieving a legacy password from a database based on the user identifier;
validating the user password based on a database password; and
initiating a legacy application emulator by keying in the user identifier and the legacy application password into the legacy application emulator.

3. The method of claim 2, further comprising prompting a user for a legacy login and password if the retrieved user password is invalid.

4. The method of claim 2, wherein validating the legacy application password comprises determining whether a duration of the password has expired.

5. The method of claim 4, further comprising prompting a user for a new password if the password duration has expired.

6. The method of claim 1, wherein the alert has an alert type and a menu sequence is associated with the alert type.

7. The method of claim 1, wherein initiating a legacy application emulator comprises initiating a browser applet that activates and configures the legacy application emulator.

8. The method of claim 1, wherein the legacy application emulator is one of an AS/400 emulator, a TN3270 emulator, or a UNIX emulator.

9. A system for generating an alert and launching an associated application into a defined state based on the alert, the system comprising:
an index containing a menu sequence referenced by an alert identifier;
a first server configured to store an alert trigger associated with the alert identifier, and upon activation of the trigger, create an alert having the alert identifier;
a second server configured to retrieve the menu sequence from the index based on the alert identifier;
a client application in communication with at least one of the first and second server and configured to display an alert link containing a message and the menu sequence;
a security server configured to receive a password from the client application and determine whether the password is valid for a legacy application; and
an applet that is activated by the alert link and that is configured to execute the menu sequence on a legacy application emulator associated with the legacy application.

10. The system of claim 9, wherein one of the first and second server is the security server.

11. The system of claim 9, wherein the security server is configured to invalidate the received password when the received password is determined to be one of missing, expired, soon to be expired, or nonmatching.

12. The system of claim 9, wherein the applet is an ActiveX component.

13. The system of claim 9, wherein the first server is configured to monitor a legacy application database for trigger conditions.

14. A computer apparatus, comprising:
a display unit that is capable of generating video images;
an input device;
a processing apparatus operatively coupled to the display unit and the input device;
the processing apparatus comprising a processor and a memory operatively coupled to the processor;
a network interface connected to a network and to the processing apparatus;
the processing apparatus being programmed to:
detect a trigger condition associated with an alert identifier;
retrieve configuration data from an index based on the alert identifier;
generate an alert link for display on the display unit when a trigger condition is detected, wherein the alert link includes the retrieved configuration data; and
initiate a legacy application emulator based on the configuration data.

15. The computer apparatus of claim 14, wherein the index is stored on a remote server and accessed via the network interface.

16. The computer apparatus of claim 14, wherein an application server is programmed to monitor a legacy application database for the trigger condition and communicate the condition to the processing apparatus.

17. The computer apparatus of claim 14, wherein the processing apparatus is further programmed to pass a user login identifier and password from a previous login attempt to the legacy application emulator.

18. The computer apparatus of claim 17, wherein the processing apparatus is further programmed to communicate with a server to validate the user identifier and password before passing the login identifier and password to the legacy application.

19. The computer apparatus of claim 18, wherein the processing apparatus is further programmed to prompt a user to enter a user identifier and password when the server determines that at least one of the previous user login identifier or password is invalid.

20. The computer apparatus of claim 18, wherein the processing apparatus is further programmed to prompt a user for a new password when the server determines that the previous password is invalid.

21. The computer apparatus of claim 14, wherein the processing apparatus is further programmed to remove the alert link when the trigger condition is no longer detected.
